(19) United States
(12) Patent Application Publication
(10) Pub. No.: US 2016/0112955 A1
(43) Pub. Date: Apr. 21, 2016

(54) COMMUNICATION PROTOCOL BETWEEN ACCESS POINT AND WIRELESS STATION

(71) Applicant: GainSpan Corporation, San Jose, CA (US)

(72) Inventor: Stephen H. Grau, Pleasanton, CA (US)

(21) Appl. No.: 14/519,063

(22) Filed: Oct. 20, 2014

(51) Int. Cl. H04W 52/02; H04W 24/10

(52) U.S. Cl. CPC H04W 52/0235; H04W 24/10

(57) ABSTRACT

An improved communication protocol between an access point and a wireless station is disclosed for ultra low-power wireless communications. The communication protocol is reduced from nine frames to seven frames by eliminating the last two packets in the sequence, allowing the wireless station to go to sleep (enter a low power state) when it sends the response rather than lingering before sleeping. The improved communication protocol allows the access point to enter its low power state following receipt of the acknowledgement from the wireless station.

### BACKGROUND

1. Field

The present disclosure relates generally to wireless devices, and, more specifically, to a communication protocol between two devices, such as an access point and a wireless station, that reduces power consumption.

2. Related Art

A wireless network generally includes two or more wireless devices that communicate with each other over a wireless medium. One example of a wireless network is a wireless local area network (WLAN) designed to operate according to IEEE 802.11 standards. One or both of a pair of wireless devices that communicate with each other may be designed to be operable in a low-power (or sleep) mode either periodically or sporadically.

One particular example of a pair of wireless devices that communicate in this manner are a wireless station and an access point. The wireless station may periodically or sporadically be fully awake to receive communications (e.g., beacons) from the access point. When the wireless station is not fully wake it is in a low-power or power-down mode. Typically, the radio portion of the wireless devices (containing the receive and transmit signal processing chains) is set to the low-power mode, since the radio portion is usually the highest power-consuming portion of a wireless device. Additionally, at least some other portions of the wireless device (e.g., some portions of a processor and some peripherals in the wireless device) may also be set to a low-power mode.

A typical high-level communication protocol between the pair of wireless devices is a request-response scenario in which the message exchanges are initiated by an access point (AP). The exchanges are timed such that the access point queues a request packet right before a beacon such that the wireless station (STA) will see its Traffic Indication Map (TIM) bit set and exits its power save mode to receive the waiting packet. The wireless station generates a response to the request and transmits the response back to the access point. The wireless station then lingers in the awake state to see if the access point is going to send another request. After a certain period, the wireless station then goes back into the power save mode by sending a QoS null frame in which the power save bit is set. The power save bit in the 802.11 standard indicates the mode of the wireless station after the successful completion of the frame exchange sequence (e.g. if the power save bit is set to 1, then the mode of the wireless station after the successful completion of the frame exchange sequence will be the power save or sleep mode). The access point then ACKs (acknowledges the QoS null frame) and then the wireless station can go back to sleep. The access point can also turn its receiver off and enter deep sleep since it knows the wireless station is asleep and will have no reason to exit power save until the next beacon period. It will be appreciated that the prior art communication protocol sometimes differs from the message sequence described above, but these prior art communication protocols are all inefficient and result in unneeded power usage by both devices (the access point and the wireless station).

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Embodiments of the invention relate to a communication protocol that eliminates the last two packets in the conventional message exchange scenario between the access point and the wireless station. In particular, the communication protocol is made more efficient by eliminating the QoS null frame transmitted by the wireless station and the access point ACK of the QoS null frame. A flag is added to the request message from the access point. The flag may have two states: okay to sleep or stay awake for additional communication. When the wireless station receives the message from the access point including the flag, the wireless station communicates to the access point that it is entering power save mode by setting the power save bit in the header of the response message. This new communication protocol allows the access point to tell the wireless station that it can go into power save as soon as it responds, rather than lingering, and, therefore, allows both the wireless station and the access point to go into low power states more quickly, and further reducing the duration of communication. As a result, advantages of the invention include reduced power consumption by both the access point and wireless station. Additionally, fewer messages are transmitted on the wireless medium, which is typically shared by many wireless stations.

In accordance with an aspect of the invention, a wireless device is disclosed that includes a receiver to receive a receive signal from one or more other wireless devices; a transmitter to transmit a transmit signal to one or more other wireless devices; a data processing system to process a plurality of receive messages received from another wireless device on the receive signal and generate a plurality of transmit messages to transmit to another wireless device on the transmit signal, and wherein at least one of the plurality of transmit messages comprises a sleep flag, wherein at least one of the plurality of receive messages comprises a response to the at least one of the plurality of transmit messages comprising the sleep flag, wherein a header of the at least one of the plurality of receive messages is set to indicate the another wireless device is entering a power save mode.

The wireless device may be an access point. The data processing system may further generate a beacon and the transmitter may further transmit the beacon.

The data processing system may further cause the wireless device to enter the power save mode. The wireless device may switch to a low power mode when the data processing system causes the wireless device to enter the power save mode. The wireless device may further include a power supply and a real time clock in communication with the data processing system. At least one of the transmitter and the receiver may demand full power in an awake mode and neither the transmitter nor the receiver may demand power during the power save mode.

The data processing system may further include computer readable medium having computer executable instructions stored thereon which cause the data processing system to process the plurality of receive messages and generate the plurality of transmit messages.

The data processing system may be further configured to wake up from a low power state, cause the transmitter to transmit a beacon, receive a QOS-Null message from the another wireless device indicating that the another wireless device is exiting a power save mode, cause the transmitter to transmit an acknowledgement of the QOS-Null message to the another wireless device, cause the transmitter to transmit the at least one of the plurality of transmit messages that comprises the sleep flag, receive an acknowledgment of the at least one of the plurality of transmit messages that comprises the sleep flag, receive the at least one of the plurality of messages that comprises the response, cause the transmitter to transmit an acknowledgment of the at least one of the plurality of messages that comprises the response, and re-enter the low power state.

The sleep flag may be in a header of the at least one of the plurality of transmit messages. The header of the at least one of the plurality of transmit messages may include an okay-to-sleep bit, and the sleep flag may be set when the okay-to-sleep bit has a value of one. The sleep flag may be a field in a payload of the at least one of the plurality of transmit messages. The sleep flag may indicate the mode of the another wireless device after a message exchange sequence.

In accordance with another aspect of the invention, a wireless device is disclosed that includes a receiver to receive a receive signal from another wireless device; a transmitter to transmit a transmit signal to the another wireless device; a data processing system to process a plurality of receive messages received from the another wireless device on the receive signal and generate a plurality of transmit messages to transmit to the another wireless devices on the transmit signal, and wherein at least one of the plurality of receive messages comprises a sleep flag, and wherein at least one of the plurality of transmit messages comprises a response to the at least one of the plurality of receive messages comprising the sleep flag, and wherein a header of the at least one of the plurality of transmit messages is set to indicate the wireless device is entering a power save mode.

The data processing system may further include computer readable medium having computer executable instructions stored thereon which cause the data processing system to process the plurality of receive messages and generate the plurality of transmit messages.

The data processing system may further generate an acknowledgement message in response to at least one of the plurality of receive messages comprising the sleep flag, and wherein the transmitter further transmits the acknowledgment message to the another wireless device.

The wireless device may be a wireless station. The another wireless device may be an access point. The receiver may receive a beacon from the another wireless device and the data processing system may further process the beacon.

The data processing system may further cause the wireless device to enter the power save mode. The wireless device may switch to a low power mode when the data processing system causes the wireless device to enter the power save mode. The wireless device may further include a power supply and a real time clock in communication with the data processing system. At least one of the transmitter and the receiver may demand full power in an awake mode and neither the transmitter nor the receiver demand power during the power save mode.

The data processing system may be further configured to wake up from a low power state, receive a beacon from another wireless device, cause the transmitter to transmit a QOS-Null message from the another wireless device indicating that the another wireless device is exiting a power save mode, receive an acknowledgement of the QOS-Null message from the another wireless device, receive the at least one of the plurality of transmit messages that comprises the sleep flag, cause the transmitter to transmit an acknowledgment of the at least one of the plurality of transmit messages that comprises the sleep flag, cause the transmitter to transmit the at least one of the plurality of messages that comprises the response, receive an acknowledgment of the at least one of the plurality of messages that comprises the response, and re-enter the low power state.

The sleep flag may be in a header of the at least one of the plurality of receive messages. The header of the at least one of the plurality of receive messages may include an okay-to-sleep bit, and the sleep flag may be set when the okay-to-sleep bit has a value of one. The sleep flag may be a field in a payload of the at least one of the plurality of receive messages. The sleep flag may indicate the mode of the wireless device after a message exchange sequence.

In accordance with yet another aspect of the invention, a method is disclosed that includes causing a wireless station to wake up from a power save mode; receiving a request message at the wireless station from an access point, the request message comprising a sleep flag; generating a response message, wherein generating the response message comprises setting a bit in the header of the response message to indicate the wireless station is entering a power save mode; transmitting the response message to the access point; and causing the wireless station to re-enter the power save mode. The method may further include periodically repeating the causing, receiving, generating, transmitting and causing steps.

The request message may include a header, and the sleep flag may be in the header of the request message. The header may include an okay-to-sleep bit, and the sleep flag may be set when the okay-to-sleep bit has a value of one. The request message may include a payload, and the sleep flag may be a field in the payload. The sleep flag may indicate the mode of the wireless station after a message exchange sequence.

The method may further include receiving a beacon from the access point; generating a QOS-Null message indicating that the wireless station is exiting the power save mode; transmitting the QOS-Null message to the access point; generating an acknowledgement of the at least one of the plurality of transmit messages that comprises the sleep flag before generating the response message; transmitting the acknowledgement before generating the response message; and receiving an acknowledgment of the response message from the access point before causing the wireless station to re-enter the power save mode.

In accordance with a further aspect of the invention, a method is disclosed that includes causing an access point to wake up from a power save mode; generating a request message comprising a sleep flag; transmitting the request message from the access point to the wireless station; receiving a response message at the access point from the wireless station, the response message indicating that the wireless station is entering a power save mode; and causing the access point to re-enter the power save mode. The method may further include periodically repeating the causing, generating, transmitting, receiving and causing steps.

The method may further include generating a beacon at the access point after causing the access point to wake up from the power save mode; transmitting the beacon from the access point; receiving a QOS-Null message at the access point from the wireless station indicating that the wireless station is exiting the power save mode; generating an acknowledgement of the QOS-Null message; transmitting the acknowledgement of the QOS-Null message from the access point to the wireless station before generating the request message; receiving an acknowledgment of the request message at the access point from the wireless station after transmitting the request message and before receiving the response message; generating an acknowledgment of the response message; transmitting the acknowledgement of the response message from the access point to the wireless station before causing the access point to re-enter the power save mode.

The request message may include a header, and the sleep flag may be in the header of the request message. The header may include an okay-to-sleep bit, and the sleep flag may be set when the okay-to-sleep bit has a value of one. The request message may include a payload, and wherein the sleep flag is a field in the payload. The sleep flag may indicate the mode of the wireless station after a message exchange sequence.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1A is a block diagram of an exemplary wireless communication system.

FIG. 1B is a block diagram of an alternative exemplary wireless communication system.

FIG. 2A is a schematic diagram showing synchronization of an access point and a wireless station in accordance with one embodiment of the invention.

FIG. 2B is a schematic diagram showing synchronization of an access point and a wireless station in accordance with one embodiment of the invention.

FIG. 3 is a message diagram showing a typical prior art communication protocol between an access point and a wireless station.

FIG. 4 is a power diagram showing power consumption of an access point using the prior art communication protocol.

FIG. 5 is a power diagram showing power consumption of a wireless station using the prior art communication protocol.

FIG. 6 is a message diagram showing a communication protocol between an access point and a wireless station in accordance with one embodiment of the invention.

FIG. 7 is a power diagram showing exemplary power consumption of an access point in accordance with one embodiment of the invention.

FIG. 8 is a power diagram showing exemplary power consumption of a wireless station in accordance with one embodiment of the invention.

FIG. 9 is a flow diagram of a method for reducing power consumption in a wireless station in accordance with one embodiment of the invention.

FIG. 10 is a detailed flow diagram of a method for reducing power consumption in a wireless station in accordance with one embodiment of the invention.

FIG. 11 is a flow diagram of a method for reducing power consumption in an access point in accordance with one embodiment of the invention.

FIG. 12 is a detailed flow diagram of a method for reducing power in an access point in accordance with one embodiment of the invention.

FIGS. 13A-B are schematic diagrams of the new request and response messages, respectively.

FIG. 14 is a block diagram of a wireless device in accordance with one embodiment of the invention.

### DETAILED DESCRIPTION

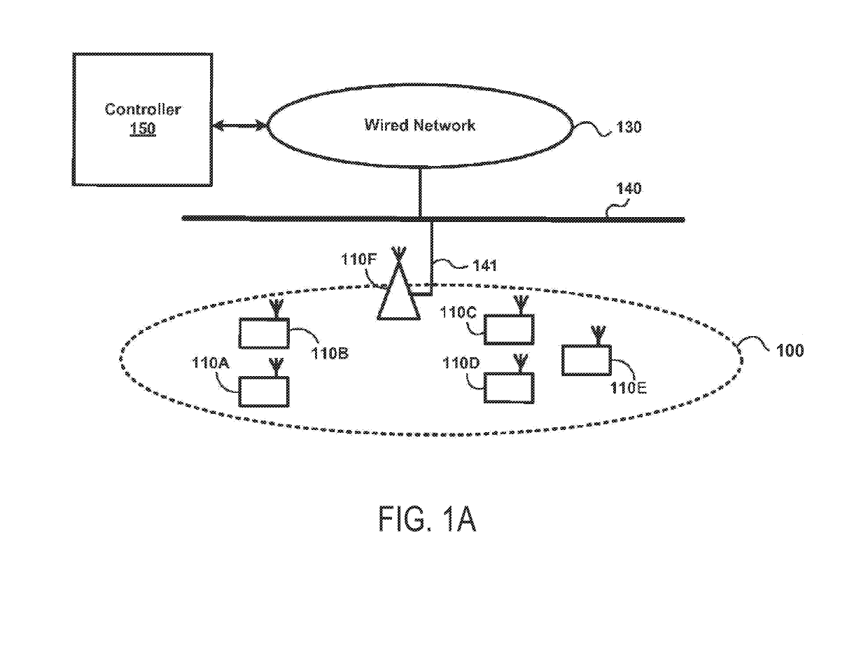

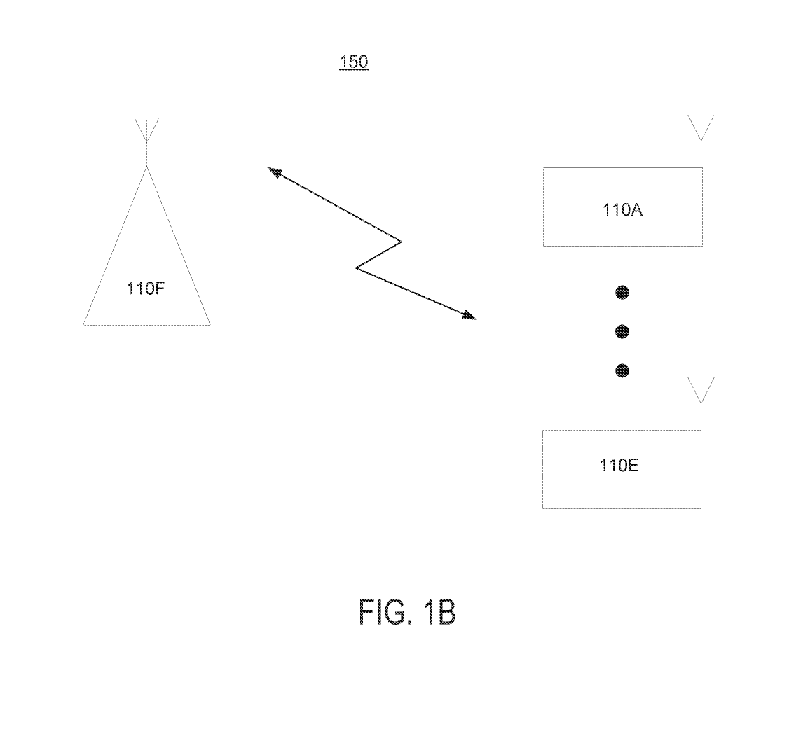

FIG. 1 illustrates an exemplary network including both wired and wireless components. It will be appreciated that the network shown in FIG. 1 and described herein is exemplary and fewer or additional components may be included in the network and other variations may be made to the exemplary network are contemplated. In addition, although certain features of the network are described with reference to a network consistent with the IEEE 802.11 standards; it will be appreciated that the invention may be implemented in networks operating with other wireless network standards, such as, for example, HIPERLAN, IEEE 802.16, Bluetooth, cellular technologies, such as CDMA, WCDMA, LTE, etc., and others, or other non-standards-based wireless networks.

The network 100 illustrated in FIG. 1A includes clients 110A-110E, access point (AP) 110F, wired network 130, wired network backbone 140 and wirelesss network manager 150. Client 110 represents a basic service set (BSS) consistent with the 802.11 standard; however, as explained above, other wireless implementations are contemplated. The term clients as used herein refers to both end devices (e.g., wireless stations) and an access point.

A wireless local area network (WLAN) generally refers to a wireless network, which facilitates multiple devices to communicate with each other over a wireless medium, and typically includes both wireless stations and an access point. Wireless stations refer to end devices, which transmit and receive packets for communication with other wireless stations and/or other devices within or external to the WLAN. Access points typically refer to devices that are typically intended for receiving and transmitting packets to and receiving packets from the wireless stations and devices external to the WLAN. Access points also manage access to the network, controlling which stations may join, authenticating stations and managing security mechanisms. Access points typically forward or switch packets, send periodic beacons and in general communicate using packet formats designed for operation as an access point.

Access point 110F is connected by a wired medium 141 to wired network backbone 140, which is connected to wired network 130. Each of the clients 110A-110E may communicate with access point 110F as well as with one another wirelessly. The client devices 110A-110E communicate with the wired network 130 through the access point 110F. The wired network 130 may represent the Internet or World Wide Web. The clients 110A-110E may be, for example, a laptop computer, smart phone, wireless sensor, or the like.

Wireless network manager 150 transmits configuration and control messages to the access point 110F. Configuration and control messages that are addressed to the clients 110A-110E are forwarded by the access point 110F to the intended client device recipient 110A-110E by sending either a unicast or a broadcast message. Although the wireless network manager 150 is shown as a separate component from the access point110F in FIG. 1A, it will be appreciated that the functionality of the wireless network manager 150 may be integrated within the access point 110F.

Wireless network manager 150 may additionally be designed to operate as a controller of BSS 110 and issue network commands to and receive data from one or more of the client devices 110A-110E, and may thus operate to provide certain desired features, such as, for example, building or plant automation, monitoring medical patients, remotely controlling a content storage device, etc. depending on the environment in which the network is deployed. The data received from the client devices 110A-110E may represent measured values of desired parameters, such as, for example, temperature, pressure, humidity, etc. in the case of building automation, measured medical data (e.g., heartbeat, blood pressure, blood glucose, temperature, etc.) about the patient in the case of medical monitoring, video or other data type content in the case of remote control of a content storage device. For example, the access point 110F may be a remote control that controls a client device 110A, and the client device 110A may be a GoPro video recorder. In another example, the client device 110A may be a human wearable tag for collecting blood pressure and the access point 110F may be a mobile phone for communicating the collected blood pressure data to a remote server accessible by a health care professional. It will be appreciated that embodiments of the invention may be implemented in numerous other scenarios.

One or more of client devices 110A-110E may be designed to operate in a “power-save” mode. For example, in the context of IEEE 802.11 standards operation, a client device (e.g., client device 110A) may operate in the standard Power Save Poll Mode (PSPM, or power-save mode, in general). Upon joining BSS 110, the client device 110A periodically “wakes up”, i.e., powers-ON for full functionality from a low power state, to transmit data to or receive data from the access point 110F or other client devices 110B-110E.

FIG. 1B illustrates an alternative network on which the invention may be implemented. The network 150 shown in FIG. 1B includes only wireless components. Specifically, as shown in FIG. 1B, network 150 includes an access point 110F and one or more wireless stations 110A-110E. In one embodiment, the network 150 includes up to 50 wireless station 110A-110E. It will be appreciated that the number of wireless stations may be any value or range of values between one and 50 or more. Wireless stations 110A-110E refer to end devices, which transmit and receive packets for communication with the access point 110F. Access point 110F send periodic beacons and transmit and receive packets with the wireless stations 110A-110E. The access point 110F shown in FIG. 1B does not include a wired connection to a wired network or a controller. The access point 110F communicates wirelessly with the wireless stations 110A-110E and may, optionally, wirelessly communicate with other devices that do have access to the wired network that are not shown in FIG. 1B, such as another access point (not shown).

The embodiment shown in FIG. 1B may be used in a scenario in which the access point 110F is remotely controlling the wireless stations 110A-110E. For example, the access point 110F may be a remote control that controls the wireless stations 110A-110E, which are GoPro video recording devices. In one specific example, the network 150 may include the one access point 110F and only one wireless station 110A. The remote control (access point 110F) transmits beacons to the one or more wireless stations 110A-110E and transmits and receives packets with the one or more wireless stations 110A-110E. In this example, the access point 110F is able to sleep when the one or more wireless stations 110A-110E connected to the access point 110F are sleeping.

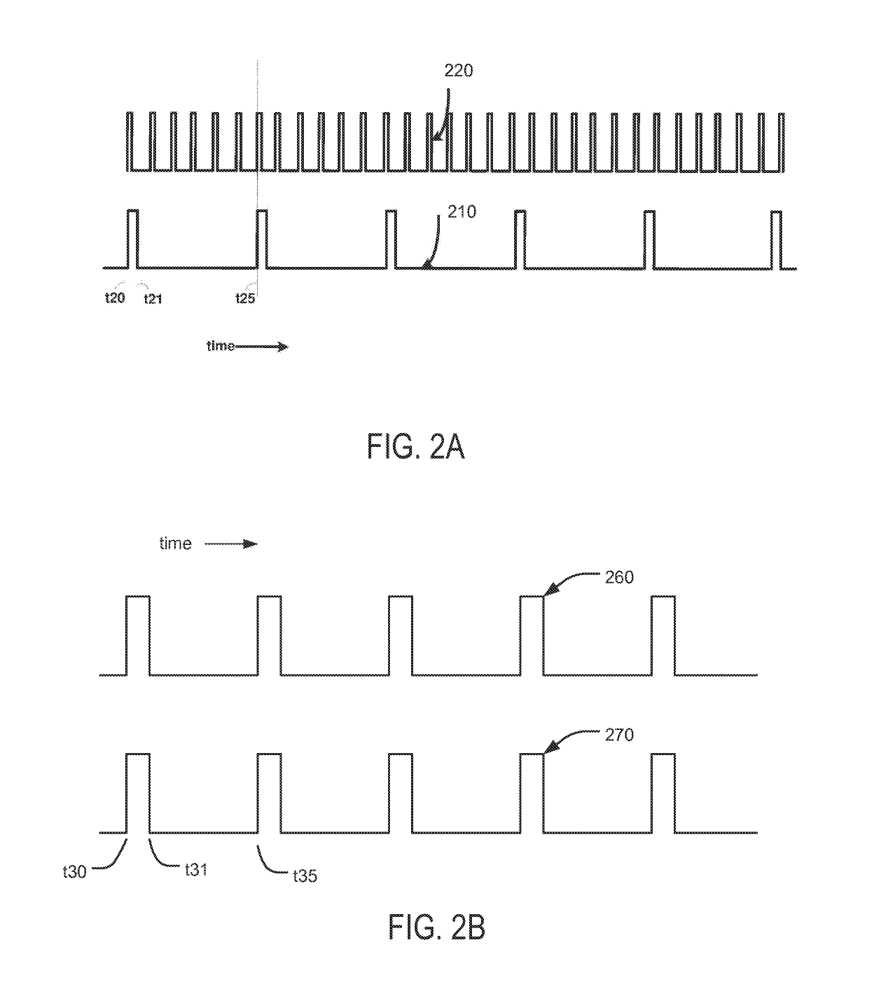

FIG. 2A illustrates an exemplary interaction between the access point and client device according to some embodiments of the invention in a network environment similar to the one shown in FIG. 1A. Waveform 210 illustrates an exemplary periodic power-ON and power-OFF sequences of the wireless client device 110A. Waveform 220 represents an example of periodic beacon frames transmitted by the access point 110F. Waveform 220 may also include data transmissions. Interval t21-t25 represents the interval between successive power-ON (wake) states and also referred to as the listen interval. Interval t20-t21 is the duration for which client 110A is in the power-ON state in each listen interval and may be different for different intervals depending on the volume of data to be transmitted or received or depending on other considerations. Upon joining BSS 110, client device 110A communicates the listen interval to access point 110F. The listen interval is typically a multiple of a beacon frame interval or beacon frame period. During the power-ON duration, a series of messages are communicated between the access point 110F and the client device 110A as will be discussed in further detail hereinafter.

In FIG. 2A, waveform 220 represents an example of periodic beacon frames transmitted by access point 110F. Beacon frames refer to a type of management frame specified by the IEEE 802.11 standards. Beacon frames are typically periodically transmitted by the access point 110F. Beacon frames are transmitted periodically to announce the presence of a wireless LAN network. Beacon frames are transmitted by the access point in an infrastructure BSS (IBSS) network. In IBSS networks, beacon frame generation is distributed among the stations in the IBSS. Some of the information contained in beacon frames includes a timestamp (for synchronization of time among the stations in a BSS), beacon frame interval (time interval between beacon frames), capability information (specifying capabilities of the wireless network), supported data rates, etc.

In FIG. 2A, durations such as t20-t21 (in general, high-logic durations of waveform 220) represent beacon frame transmissions. In FIG. 2, the listen interval (t20-t25) of client 110A is shown as equaling six beacon frame intervals of beacon frames transmitted by access point 110F. However, the specific listen interval may be set based on specific considerations. For example, if very low power operation is required for client 110A and data exchange between client 110A and other client devices in BSS 110 are relatively infrequent, a large value (e.g., 100) may be set for the listen interval.

In FIG. 2A, client 110A synchronizes its local clock with respect to the clock of the access point 110F based on the time stamp contained in a beacon frame. Client 110A, when operating in power-save mode, sets its listen interval equal to a multiple of the beacon time interval, and aligns its power-ON durations (such as in interval t20-t21 in FIG. 2A) with the beacon frames.

FIG. 2B illustrates an exemplary interaction between the access point and client device according to some embodiments of the invention in a network environment similar to the one shown in FIG. 1B in which there is one access point and one wireless station. Waveform 260 illustrates an exemplary periodic power-ON and power-OFF sequences of the wireless client device 110A, and waveform 270 represents an example of periodic beacon frames transmitted by the access point 110F, which may also include data transmissions. Interval t30-t31 represents the power-ON/power-off duration if the wireless station, and interval t31-t35 represents the interval between successive power-ON (wake) states and is the listen interval. As shown in FIG. 2B, in network environments such as the one shown in FIG. 1B, the waveforms 260, 270 are synchronized because the access point 110F is only communicating with one wireless station 110A.

The client device (or wireless station) and access point may enter sleep mode by powering down at least a portion of the device. In one embodiment, the circuit portions that are powered-down during sleep mode are the receiver circuitry and the transmit circuitry. The specific receiver and transmit circuitry that may be shut down may include the radio frequency (RF) and the intermediate frequency (IF) circuit portions. Powering down may be in the form of complete removal of the power supply from the device components or operation of the circuit portions at a reduced speed using a lower-frequency clock. In another embodiment, the processor (or portions of the processor) and memory (or portions of the memory) are powered down in addition to the receive/transmit circuitry. It will be appreciated that typically certain components of the device are powered down before others are powered down when entering the sleep mode (i.e., a power ramp down). In yet another embodiment, the device may be completely power downed (i.e., full power down). For example, in the case of a remote control access point, a power button on the remote control may be pushed to do a full power down of the access point (and re-pushing the power button wakes up the remote control). The techniques described above for entering a low power mode or sleep mode are merely exemplary and persons of skill in the art will recognize that a number of other techniques may be used to cause a wireless station and/or access point to enter a low power or sleep mode.

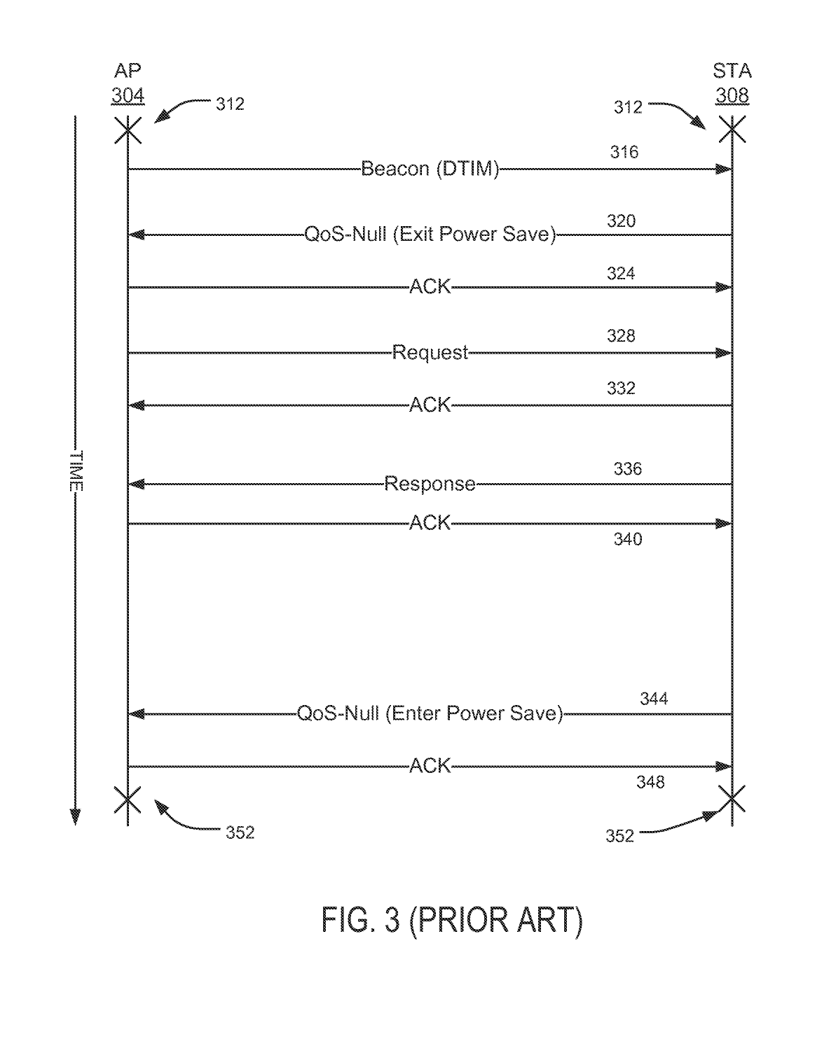

FIG. 3 illustrates the prior art message flow sequence or communication protocol 300 between an access point 304 and wireless station 308 described above in the Background section. The prior art communication protocol 300 begins at step 312 when the access point 304 and the wireless station 308 wake up. The access point 304 and the wireless station 308 wake up by providing power to certain portions of the devices (e.g., receiver, transmitter, etc.). If the access point 304 has data to transmit to a wireless station 308, the access point 304 generates a request message that is queued for transmission to the wireless station 308. The access point may then go back to sleep and wake up later to later transmit the request message or may stay awake to transmit the request message as explained in further detail below.

At step 316, the access point 304 transmits a beacon that is received at the wireless station 308. If the access point 304 has data for the wireless station 308, the beacon will indicate using the TIM that queued request is waiting for the wireless station 308 at the access point 304.

At step 320, the wireless station 308 transmits a QOS-Null message to the access point 304, which indicates the wireless station 308 is exiting (or has exited) the power save mode. The QOS-Null message does not contain any data but includes a flag that indicates the wireless station 308 is exiting the power save mode (e.g., by clearing the power save bit/setting the power save bit to 0). At step 324, the access point 304 transmits an acknowledgement (ACK) message to the wireless station 308.

At step 328, the access point 304 transmits a request message to the wireless station 308. At step 332, the wireless station 308 transmits an ACK message to the access point 304, acknowledging receipt of the request message.

At step 336, the wireless station 308 transmits a response to the request message to the access point 304. At step 340, the access point 304 transmits an ACK message to the wireless station 308.

At step 344, the wireless station 308 transmits a QOS-Null message to the access point 304 indicating that the wireless station 308 intends to enter the power save mode (e.g., the power save bit is set/the power save bit has a value of 1). At step 348, the access point 304 transmits an ACK message to the wireless station 308, acknowledging receipt of the QOS-Null message.

At step 352, after a period of time, both the access point 304 and the wireless station 308 enter the power save mode. It will be appreciated that the access point 304 and wireless station 308 may not enter the power save mode at the exact same time. For example, the wireless station 308 may enter the power save mode before the access point 304 or vice versa. The period of time between step 348 and step 352 is typically any value or range of values between about 1 ms-10 ms (e.g., about 3 ms), but can be more than 10 ms. These steps are repeated periodically (e.g., around the time of each beacon transmission described above with reference to FIG. 2).

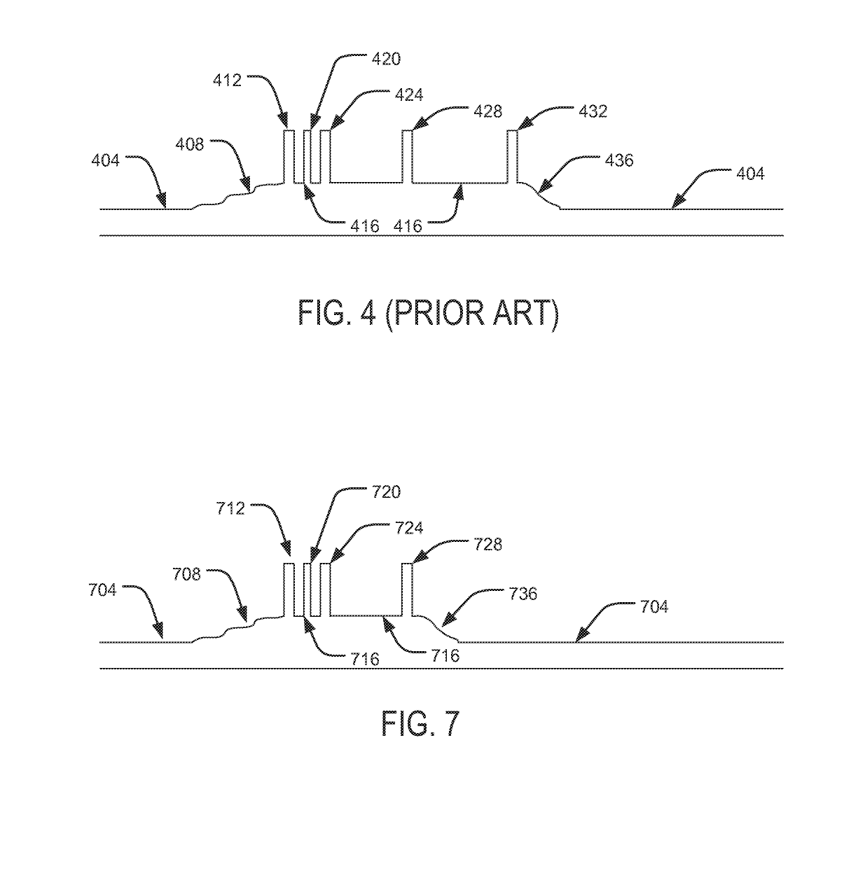

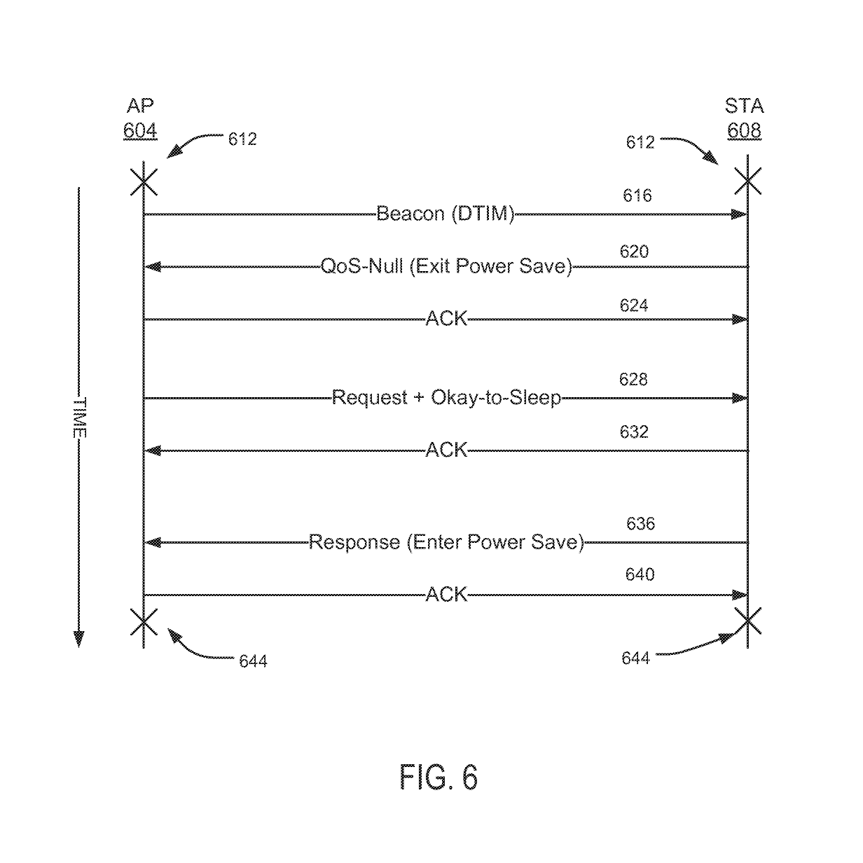

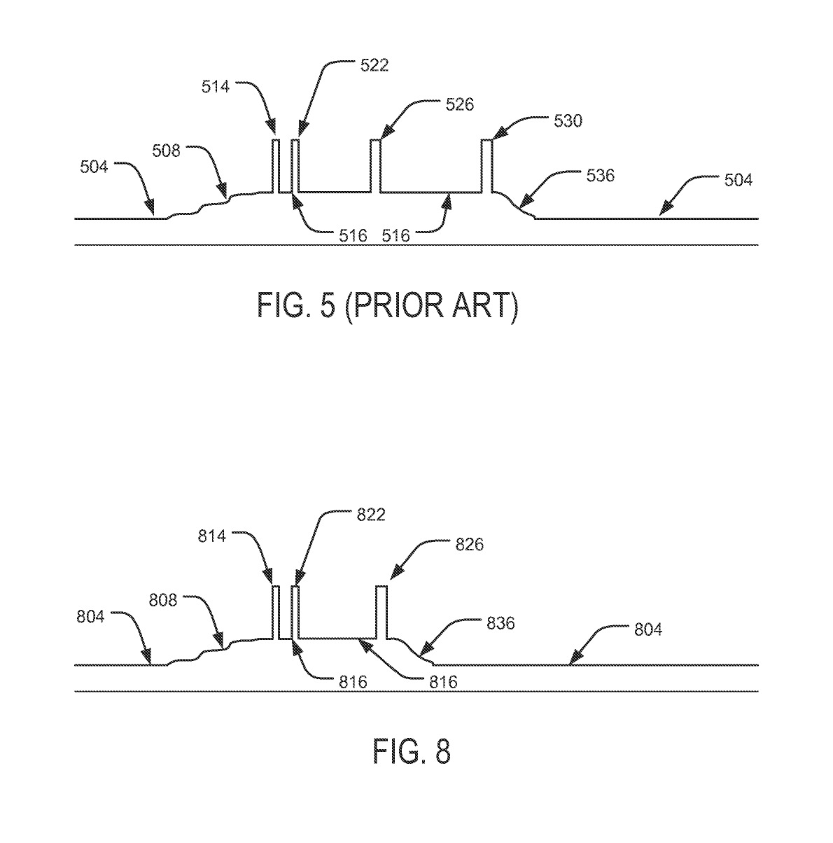

FIGS. 4 and 5 are power diagrams showing the power consumption of the access point and wireless station, respectively, during the communication protocol 300 shown in FIG. 3.

With reference to FIG. 4, the access point begins in a sleep mode, 404, and then consumes an increasing amount of power during the wake-up period 408 (corresponding to step 312of FIG. 3) (i.e., a power ramp up). The power level of the access point includes a first transmit spike 412 when it transmits the beacon (corresponding to step 316) and then returns to a lower, receive power level 416 when it is in a receive mode. The power level of the access point includes a second transmit spike 420 when the access point transmits the ACK of the QOS-Null message (corresponding to step 324) and then returns again to the receive power level 416. The power level of the access point includes a third transmit spike 424 when the access point transmits the request (corresponding to step 328) and then returns again to the receive power level 416. The power level of the access point includes a fourth transmit spike 428 when the access point transmits the ACK of the response message (corresponding to step 340) and then returns again to the receive power level 416. The access point then lingers in the receive mode 416 until it receives the QOS-Null message from the wireless station. The power level of the access point includes a fifth transmit spike 432 when the access point transmits the ACK of the QOS-Null message (corresponding to step 348). Finally, the access point powers down 436 to renter the sleep mode 404 (corresponding to step 352 of FIG. 3).

With reference now to FIG. 5, the wireless station begins in a sleep mode 504, and then consumes an increasing amount of power during the wake-up period 508 (corresponding to step 312 of FIG. 3) (i.e., a power ramp up). The power level of the wireless station begins in the receive mode 516 (while waiting to receive the beacon from the access point). The power level of the wireless station includes a first transmit spike 514 when it transmits the QOS-Null message (corresponding to step 320), and then returns to a lower, receive power level 516 when it is in a receive mode. The power level of the wireless station includes a second transmit spike 522 when it transmits the ACK of the request message (corresponding to step 332) and then returns to the receive power level 516. The power level of the wireless station includes a third transmit spike 526 when the wireless station transmits the response message (corresponding to step 336), and then returns to the receive power level 516. The wireless station then lingers at the receive power level 516 for a period of time. The power level of the wireless station includes a fourth transmit spike 530 when the wireless station transmits the QOS-Null message (corresponding to step 344) and then returns to the receive power level 516. Finally, after receiving the ACK (step 348), the wireless station powers down 536 to renter the sleep mode 504 (corresponding to step 352 of FIG. 3).

As previously explained the prior art communication protocol as shown in FIG. 3 is disadvantageous because the wireless station lingers in the awake state to see if the access point is going to send another request before sending a QoS null frame with the power save bit set. Only after the access point acknowledges the QoS null frame does the wireless station go to sleep. In addition in networks such as the one shown in FIG. 1A, the access point can also turn its receiver off because it knows the wireless station is sleeping and won't have a reason to exit the power save until the next beacon transmission period.

Embodiments of the claimed invention eliminate the last two packets in the sequence. A flag is added to the request message that allows the access point to indicate to the wireless station that the wireless station can go into the power save mode as soon as it completes the response message sequence (the response and acknowledgment of the response). As a result, the wireless station does not linger. The wireless station sends a response message indicating that it is entering the power save mode. The access point can also go to sleep shortly after sending the acknowledgment (ACK). The access point may stay awake for a brief period after the ACK to cover the case in which the ACK is not received by the STA. If the ACK is not received by the wireless station (STA), the STA retries the response message. Thus, the nine frame sequence of the prior art communication protocol is shortened to a seven frame communication protocol, and also shortening the duration of the communication protocol.

The benefits of the improved communication protocol include reduced power consumption by both the access point and the wireless station because fewer frames or messages are transmitted and both devices spend more time sleeping. Specifically, the average power consumption is reduced by at least about 10% for each request-response sequence.

FIG. 6 illustrates a communication protocol 600 between an access point 604 and a wireless station 608 in accordance with embodiments of the invention. The communication protocol 600 begins at step 612 when the access point 604 and the wireless station 608 wake up. It will be appreciated that the access point 604 and the wireless station 608 may go through a series of steps to return to full power (i.e., ramp-up to full power) or may transition directly from a lower power or sleep mode to a full power or awake mode.

The access point 604 generates and queues a request message when the access point 604 has data that needs to be transmitted to the wireless station 608. At step 616, the access point 604 transmits a beacon that is received at the wireless station 608. If the access point 604 has a message queued for the wireless station 608, the beacon will indicate that there is data waiting for the wireless station 608 at the access point 604 by setting the station's bit in the TIM (Traffic Indication Map). It will be appreciated that beacons may be transmitted from the access point 604 to the wireless station 608 that do not have the TIM bit set (i.e., there is no request message in the queue). The communication exchange between the access point 608 and the wireless station 608 is not different than the prior art communication exchange if the TIM is not set (i.e., there is no request message queued).

At step 620, the wireless station 608 transmits a QoS-Null message to the access point 605. The power management bit in the MAC header of the QoS-Null message is set to 0. This QoS-Null message in which the power management bit is cleared/set to 0, indicating that the wireless station 608 has already exited or is in the process of exiting the power save mode. At step 624, the access point 604 transmits an acknowledgement (ACK) message to the wireless station 608, acknowledging receipt of the QoS-Null message.

At step 628, the access point 604 transmits a request message that includes an Okay-to-Sleep flag to the wireless station 608. In one embodiment, a field in the payload of the message may be designated to indicate that it is ok for the wireless station to sleep. For example, the payload may include the phrase “Okay-to-Sleep” or the like. In another embodiment, a bit in the header of the request message may be set to indicate it is ok for the wireless station to sleep (i.e., without including anything in the payload of the message). In yet another embodiment, a bit in the header of the request message to look for a flag in the payload of the message, and the flag in the payload of the message may indicate to the wireless station 608 that the wireless station 608 may go to sleep. At step 632, the wireless station 608 transmits an ACK message to the access point 604, acknowledging receipt of the request message.

At step 636, the wireless station 608 transmits a response to the request message to the access point 604. The response includes a flag or bit in its header that indicates the wireless station 608 is entering the power save mode. For example, the power management bit in the MAC header of the response may be set to 1 to indicate that the wireless station is prepared to enter or is actually entering the power save mode. At step 640, the access point 604 transmits an ACK message to the wireless station 608.

At step 644, both the access point 604 and the wireless station 608 go to sleep. It will be appreciated that the access point 604 and wireless station 608 do not need to go sleep at the exact same time. For example, the wireless station 608 may go to sleep before the access point 604 or vice versa. In one specific example, the access point 604 may linger to cover the situation in which the ACK message (step 640) is lost. In that case, the wireless station 608 re-sends the response message (i.e., repeats step 636) because it did not receive the ACK (step 640) from the access point 604. One of skill in the art will appreciate that the message communication protocol is shorter in duration because the wireless station 608 does not linger and includes two fewer messages than the prior art communication protocol. This communication protocol 600 is repeated periodically (e.g., every second).

FIGS. 7 and 8 are power diagrams showing the power consumption of the access point and wireless station, respectively, during the communication protocol shown in FIG. 6.

With reference to FIG. 7, the access point begins in a sleep mode 704, and then consumes an increasing amount of power during the wake-up period 708 (corresponding to step 612 of FIG. 6) (i.e., a power ramp up). The power level of the access point includes a first transmit spike 712 when it transmits the beacon (corresponding to step 616) and then returns to a lower, receive power level 716 when it is in a receive mode. The power level of the access point includes a second transmit spike 720 when the access point transmits the ACK of the QOS-Null message (corresponding to step 624) and then returns again to the receive power level 716. The power level of the access point includes a third transmit spike 724 when the access point transmits the request (corresponding to step 628) and then returns again to the receive power level 716. The power level of the access point includes a fourth transmit spike 728 when the access point transmits the ACK of the response message (corresponding to step 640). After transmitting the ACK of the response message, the access point powers down 736 to renter the sleep mode 704 (corresponding to step 644 of FIG. 6).

With reference now to FIG. 8, the wireless station begins in a sleep mode 804, and then consumes an increasing amount of power during the wake-up period 508 (corresponding to step 612 of FIG. 6) (i.e., a power ramp up). The power level of the wireless station begins in the receive mode 816 (while waiting to receive the beacon from the access point). The power level of the wireless station includes a first transmit spike 814 when it transmits the QOS-Null message (corresponding to step 620), and then returns to a lower, receive power level 816 when it is in a receive mode. The power level of the wireless station includes a second transmit spike 822 when it transmits the ACK of the request message (corresponding to step 632) and then returns to the receive power level 816. The power level of the wireless station includes a third transmit spike 826 when the wireless station transmits the response message (corresponding to step 636), and then returns to the receive power level 816. Then, the wireless station powers down 836 to renter the sleep mode 804 (corresponding to step 644 of FIG. 6).

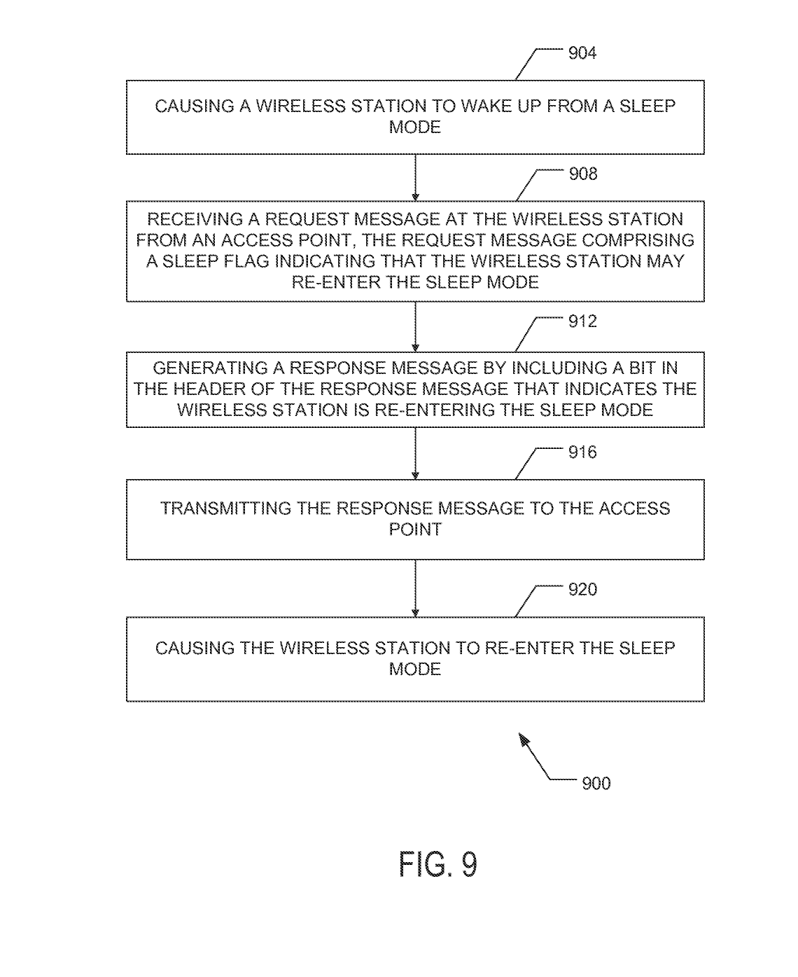

FIG. 9 is a flow diagram showing a process 900 for reducing power consumption in a wireless station in accordance with some embodiments of the invention. It will be appreciated that the process 900 described below is exemplary and may include a fewer or greater number of steps, and that the order of at least some of the steps may vary from that described below.

The process 900 includes causing a wireless station to wake up from a sleep mode (block 904). The process 900 continues by receiving a request message at the wireless station from an access point, the request message comprising a sleep flag indicating that the wireless station may re-enter the sleep mode (block 908). The process 900 continues by generating a response message by including a bit in the header of the response message that indicates the wireless station is re-entering the sleep mode (block 912) and transmitting the response message to the access point (block 916). The process continues by causing the wireless station to re-enter the sleep mode (block 920).

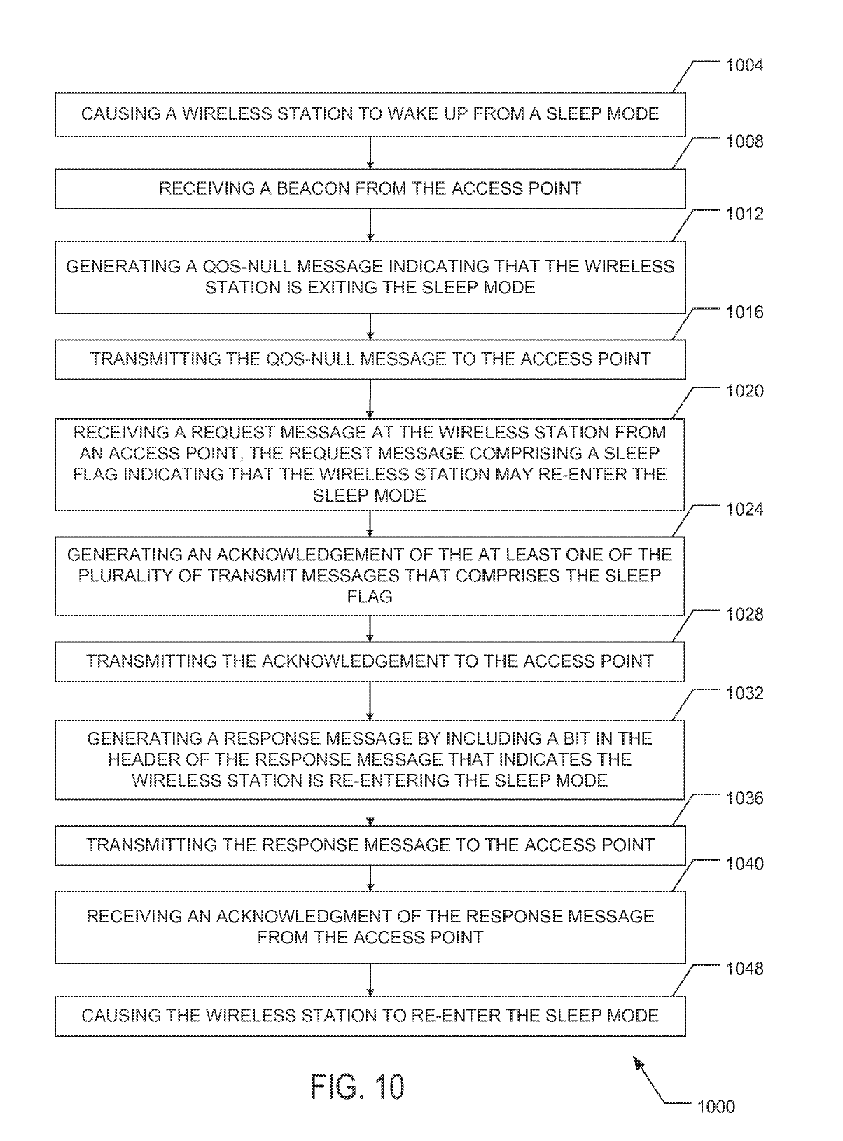

FIG. 10 is a flow diagram showing a detailed communication process 1000 from the perspective of a wireless station in accordance with some embodiments of the invention. It will be appreciated that the process 1000 described below is merely exemplary and may include a fewer or greater number of steps, and that the order of at least some of the steps may vary from that described below.

The process 1000 begins by causing a wireless station to wake up from a sleep mode (block 1004). The process 1000 continues by receiving a beacon from the access point (block 1008). The process continues by generating a QOS-Null message indicating that the wireless station is exiting the sleep mode (block 1012) and transmitting the QOS-Null message to the access point (block 1016).

The process 1000 continues by receiving a request message at the wireless station from an access point, the request message comprising a sleep flag indicating that the wireless station may re-enter the sleep mode (block 1020). The process continues by generating an acknowledgement of the at least one of the plurality of transmit messages that comprises the sleep flag (block 1024) and transmitting the acknowledgement (block 1028).

The process 1000 continues by generating a response message by including a bit in the header of the response message that indicates the wireless station is re-entering the sleep mode (block 1032) and transmitting the response message to the access point (block 1036).

The process 1000 continues by receiving an acknowledgment of the response message from the access point (block 1040) and then causing the wireless station to re-enter the sleep mode (block 1048).

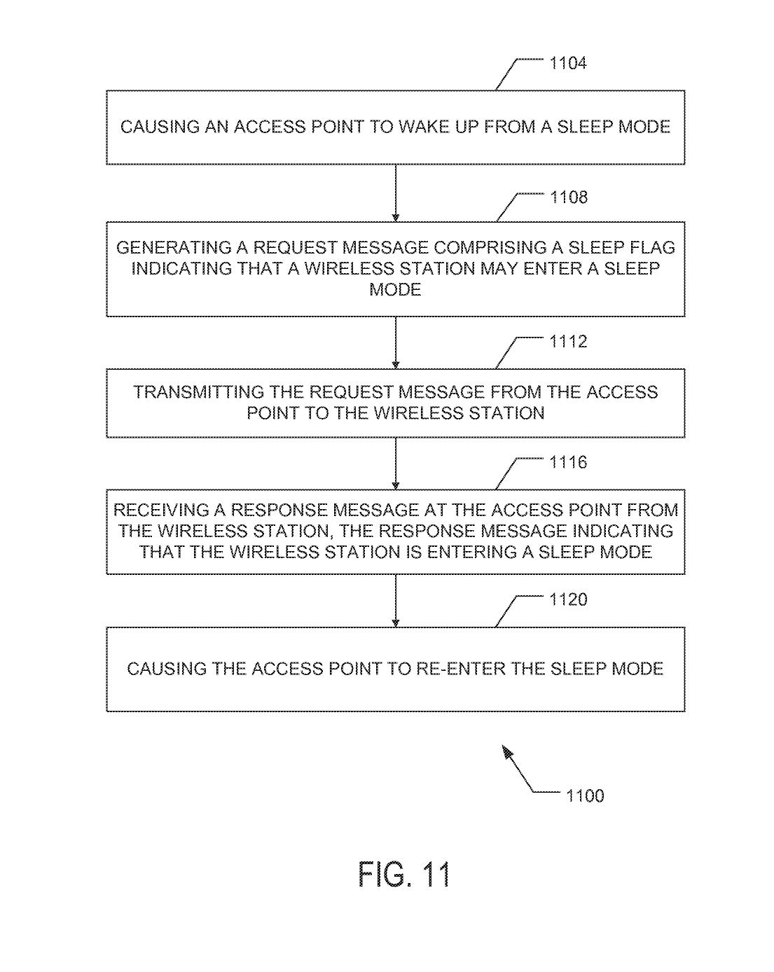

FIG. 11 is a flow diagram showing a process 1100 for reducing power consumption in an access point in accordance with some embodiments of the invention. It will be appreciated that the process 1100 described below is merely exemplary and may include a fewer or greater number of steps, and that the order of at least some of the steps may vary from that described below.

The process 1100 includes causing an access point to wake up from a sleep mode (block 1104). The process 1100 continues by generating a request message comprising a sleep flag indicating that a wireless station may enter a sleep mode (block 1108). The process 1100 continues by transmitting the request message from the access point to the wireless station (block 1112). The process 1100 continues by receiving a response message at the access point from the wireless station, the response message indicating that the wireless station is entering a sleep mode (block 1116). The process continues by causing the access point to re-enter the sleep mode (block 1120).

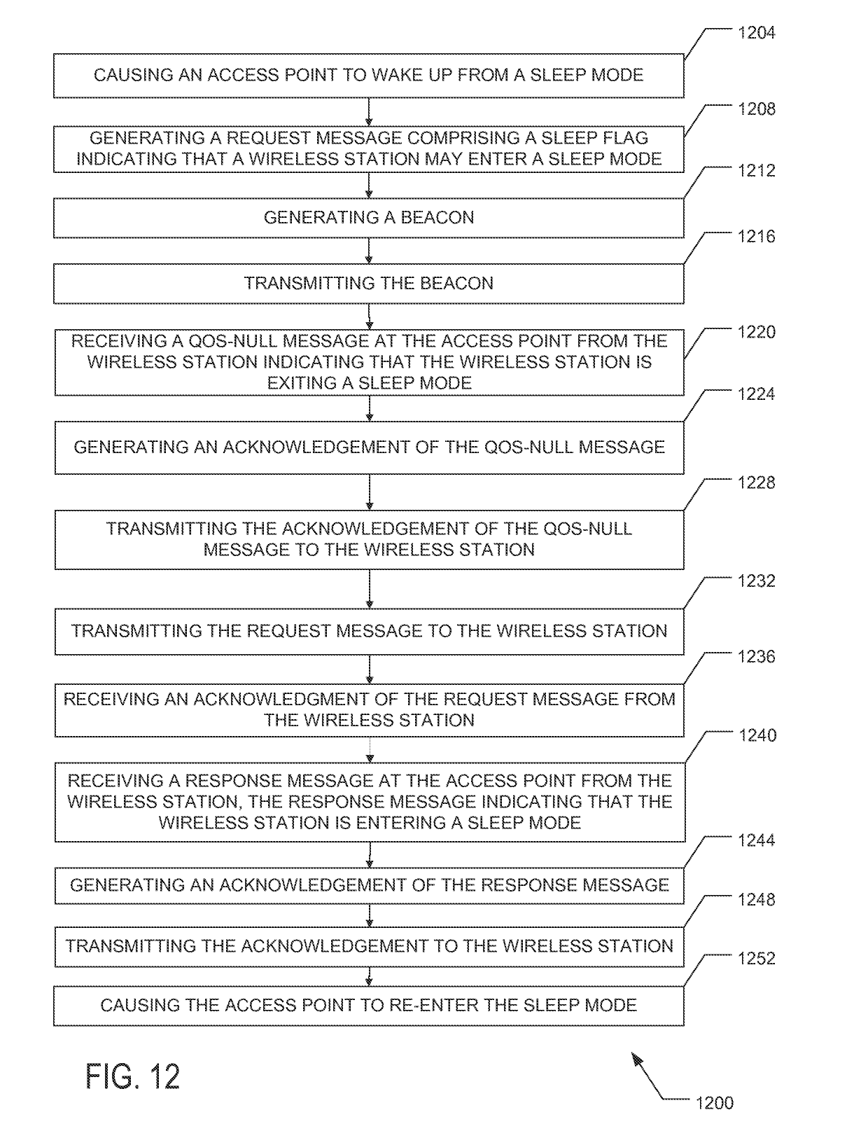

FIG. 12 is a flow diagram showing a detailed communication process 1200 from the perspective of an access point in accordance with some embodiments of the invention. It will be appreciated that the process 1200 described below is merely exemplary and may include a fewer or greater number of steps, and that the order of at least some of the steps may vary from that described below.

The process 1200 includes causing an access point to wake up from a sleep mode (block 1204). The process 1200 continues by generating a request message comprising a sleep flag indicating that a wireless station may enter a sleep mode (block 1208). The process continues by generating a beacon at the access point after causing the access point to wake up from a sleep mode (block 1212) and transmitting the beacon from the access point(block 1216).

The process 1200 continues by receiving a QOS-Null message at the access point from the wireless station indicating that the wireless station is exiting a sleep mode (block 1220), generating an acknowledgement of the QOS-Null message (block 1224), and transmitting the acknowledgement of the QOS-Null message from the access point to the wireless station before generating the request message (block 1228).

The process 1200 continues by transmitting the request message from the access point to the wireless station (block 1232). The process 1200 continues by receiving an acknowledgment of the request message at the access point from the wireless station (block 1236).

The process 1200 continues by receiving a response message at the access point from the wireless station, the response message indicating that the wireless station is entering a sleep mode (block 1240). The process 1200 continues by generating an acknowledgment of the response message (block 1244) and transmitting the acknowledgement of the response message from the access point to the wireless station (block 1248). The process continues by causing the access point to re-enter the sleep mode (block 1252).

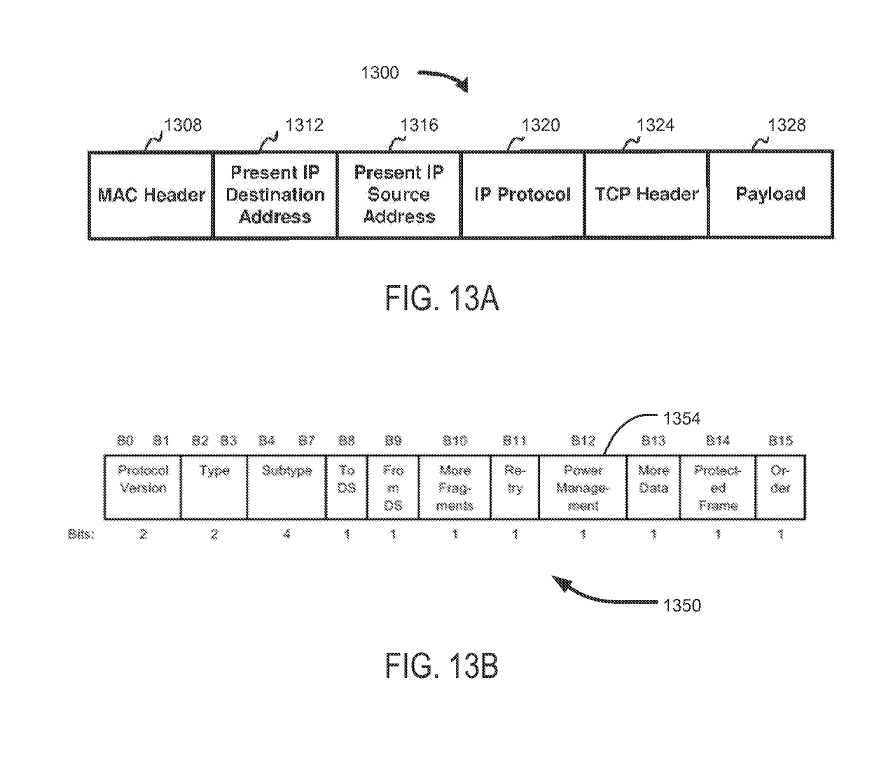

FIG. 13A is a schematic diagram showing the typical format of messages 1300, such as the request and response messages that include the Okay-to-Sleep flag and the bit indicating that the wireless station is entering the power save mode, respectively. FIG. 13B is a schematic diagram showing a portion of the MAC header of the messages 1300 in further detail.

FIG. 13A illustrates a typical message or frame format for IEEE 802.11 communications. As shown in FIG. 13A, the message 1300 typically includes a MAC header 1308, the present IP address 1312, the present IP source address 1316, the IP protocol 1320, the TCP header 1324 and the payload 1328. FIG. 13B illustrates a portion 1350 of the MAC header 1308 in further detail. As shown in FIG. 13B, the MAC header portion 1350 includes a power management subsection 1354.

In the request message that is transmitted from the access point to the wireless station, an “Okay-to-Sleep” flag or similar message is provided. In one embodiment, an “Okay-to-Sleep” or similar message may be included in the payload 1328 of the message 1300. For example, a field in the payload 1328 may be designated as an “Okay-to-Sleep” field. In another example, a bit in the MAC header 1308 may be set to indicate the wireless device may enter the power save mode (e.g., 1=okay-to-sleep and 0=not okay-to-sleep). In yet another example, a new subtype or new bit can be added as a control field to the header of the message that is an “Okay-to-Sleep” bit. In a further example, another sub-frame or another header can include the “Okay-to-Sleep” flag. In a still further example, the “Okay-to-Sleep” flag may be provided in a QOS header. In yet another embodiment, a combination of a bit or field in the message header and a field in the payload may be used to indicate the wireless device may enter the power save mode.

In the response message that is transmitted by the wireless station to the access point, the power management subsection or bit 1354 may be set to indicate that the wireless station is entering or remaining in power save or sleep mode. In particular, the bit 1354 is typically set to 1 when the wireless station is entering the power save or sleep mode, and the bit 1354 is typically set to 0 when the wireless station is exiting the power save or sleep mode.

With the PS poll mode of power save the station stays in power save and keeps requesting messages until there are no more messages waiting as indicated by the More Data bit (B13). The More Data Bit is not the same as the Okay-to-Sleep flag. The Okay-to-Sleep flag indicates the application does not intend to generate, queue and transmit any more requests. In contrast, the More Data bit only indicates whether there are more frames for the station that are already queued for transmission. The future intent of the higher level application software cannot be determined from the More Data bit; in contrast, the Okay-to-Sleep flag is explicit about the future intent of the higher level application software.

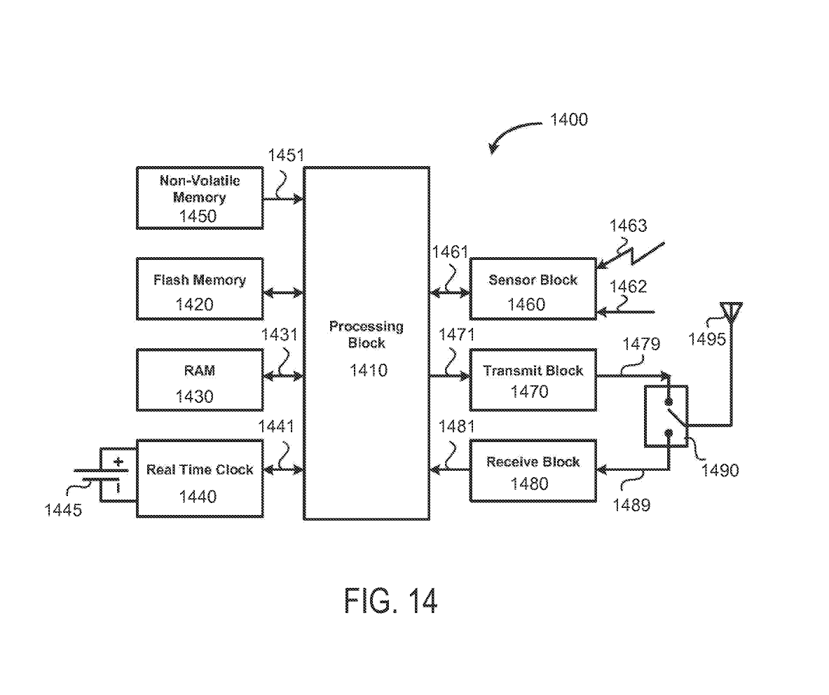

FIG. 14 illustrates exemplary components of a wireless device 1400. The wireless device 1400 corresponds to the wireless station or client device 110A-110E shown in FIG. 1 and described herein. It will be appreciated that the access point 110F typically includes the similar components to those shown in FIG. 14; however, the access point 110F may include fewer components than shown in the wireless device of FIG. 14 and may also include additional components than those shown in FIG. 14, and that the arrangement of the components may differ.

Exemplary implementations of wireless device 1400 are disclosed in U.S. Pat. No. 7,941,682, entitled “Optimum Power Management of System on Chip Based on Tiered States of Operation”, issued May 10, 2011, and U.S. Patent Publication Nos. 2009/0016251, entitled “Management System and Method of Low Power Consuming Devices, filed Jul. 13, 2007, 2009/0077404, entitled “Method and System for Reducing Power Consumption of System on Chip Based Analog-to-Digital Control Circuitry,” filed Sep. 14, 2007, each of which is assigned to Gainspan, Inc., the entireties of each of which are hereby incorporated by reference. It will be appreciated that other implementations of the wireless device 1400 are contemplated and such wireless device 1400 should not be limited to the disclosures incorporated by reference or the exemplary wireless device illustrated in FIG. 14.

Wireless device 1400 includes a data processing system 1410, flash memory 1420, random access (RAM) memory 1430 a real-time clock (RTC) 1440, power supply 1445, non-volatile memory 1450, sensor(s) 1460, a transmitter 1470, a receiver 1480, switch 1490 and antenna 1495. It will be appreciated that the wireless device 1400 may be implemented as a system-on-chip (SoC) or as separate integrated circuits (IC) or combinations thereof. Additionally, it will be appreciated that the wireless device 1400 may have fewer or greater components than those shown in FIG. 14 and that the arrangement of the components shown in FIG. 14 may differ.

Data processing system 1410 is a processor that may contain one or more processing units. In embodiments in which the data processing system 1400 includes multiple processing units, each processing unit may be designed for a specific task. Alternatively, the data processing system 1410 may contain a general purpose processing unit. In yet another embodiment, the data process system 1410 may contain multiple general purpose processing units that share processing for all tasks in a mutual way.

Flash memory 1420 contains memory locations organized as blocks. A block represents a set of memory locations (typically continuous in terms of memory address) which are to be all erased before data can be rewritten into any location. Flash memory 1420 may be used to store data from sensor(s) 1460 via data processing system 1410 and/or store program code.

RAM 1430 and non-volatile memory 1450 (which may be implemented in the form of read-only memory (ROM)) constitute computer program products or machine readable medium which provide instructions to data processing system 1410. RAM 1430 communicates with data processing system via path 1431. The non-volatile memory 1450 may include sub-components (not shown), such as OTP and EEPROM.

RTC 1440 operates as a clock and provides the current time to data processing system 1410 on path 1441. RTC 1440 may be backed-up by power supply 1445. RTC 1440 may also contain memory to store critical information received from the data processing system 1410.

Non-volatile memory 1450 is a non-transitory computer readable medium that stores instructions, which when executed by the data processing system 1410, cause the wireless device 1400 to process the data and messages received from the receiver and generate the data and messages for transmission by the transmitter. The non-volatile memory communicates with data process system 1410 via path 1451.

Sensor(s) 1460 may include one or more sensors as well as corresponding signal conditioning circuitry. As an alternative, sensor(s) may instead be any data capture device, such as a video recording device or other data collection or capture devices. Sensed parameters or data are transmitted on path 1461 via a wired path 1462 or wireless path 1463.

Transmitter 1470 receives data to be transmitted from data processing system 1410 on path 1471. Further, the transmitter 1470 generates a modulated radio frequency (RF) signal according to IEEE 802.11 standards and transmits the RF signal via switch 1490 and antenna 1495.

Receiver 1480 receives an RF signal bearing data via switch 1490 and antenna 1495. The receiver 1480 further demodulates the RF signal and provides extracted data to the data processing system 1410 on path 1481.

Antenna 1495 operates to receive from and transmit to a wireless medium wireless signals containing data and messages. Switch 1490 may be controlled by the data processing system 1410 to connect antenna 1495 to the receiver 1480 via path 1489 or transmitter via path 1479 depending on whether the wireless station is receiving or transmitting.

One or more of the methodologies or functions described herein may be embodied in a computer-readable medium on which is stored one or more sets of instructions (e.g., software). The software may reside, completely or at least partially, within memory, as described above, and/or within the data processing system during execution thereof. The software may further be transmitted or received over a network.

The term “computer-readable medium” should be taken to include a single medium or multiple media that store the one or more sets of instructions. The term “computer-readable medium” shall also be taken to include any medium that is capable of storing, encoding or carrying a set of instructions for execution by a machine and that cause a machine to perform any one or more of the methodologies of the invention. The term “computer-readable medium” shall accordingly be taken to include, but not be limited to, solid-state memories, and optical and magnetic media.

Embodiments of the invention have been described through processes or flow diagrams at times, which are defined by executable instructions recorded on computer readable media which cause a computer, microprocessors or chipsets to perform method steps when executed. The process steps have been segregated for the sake of clarity. However, it should be understood that the steps need not correspond to discreet blocks of code and the described steps can be carried out by the execution of various code portions stored on various media and executed at various times.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The invention has been described in relation to particular examples, which are intended in all respects to be illustrative rather than restrictive. Those skilled in the art will appreciate that many different combinations of hardware, software, and firmware will be suitable for practicing the present invention.

The present invention has been described in relation to particular examples, which are intended in all respects to be illustrative rather than restrictive. Those skilled in the art will appreciate that many different combinations will be suitable for practicing the present invention. Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A wireless device comprising:
a receiver to receive a receive signal from one or more other wireless devices;
a transmitter to transmit a transmit signal to one or more other wireless devices;
a data processing system to process a plurality of receive messages received from another wireless device on the receive signal and generate a plurality of transmit messages to transmit to another wireless device on the transmit signal, and wherein at least one of the plurality of transmit messages comprises an okay-to-sleep flag, wherein at least one of the plurality of receive messages comprises a response to the at least one of the plurality of transmit messages comprising the okay-to-sleep flag, wherein a header of the at least one of the plurality of receive messages is set to indicate the another wireless device is entering a power save mode.

2. The wireless device of claim 1, wherein the wireless device comprises an access point.

3. The wireless device of claim 1, wherein the data processing system generates a beacon and wherein the transmitter transmits the beacon.

4. The wireless device of claim 1, wherein the data processing system further causes the wireless device to enter the power save mode.

5. The wireless device of claim 4, wherein the wireless device switches to a low power mode when the data processing system causes the wireless device to enter the power save mode.

6. The wireless device of claim 4, further comprising a power supply and a real time clock in communication with the data processing system.

7. The wireless device of claim 1, wherein at least one of the transmitter and the receiver demand full power in an awake mode and neither the transmitter nor the receiver demand power during the power save mode.

8. The wireless device of claim 1, wherein the data processing system comprises computer readable medium having computer executable instructions stored thereon which cause the data processing system to process the plurality of receive messages and generate the plurality of transmit messages.

9. The wireless device of claim 1, wherein the data processing system is further configured to wake up from a low power state, cause the transmitter to transmit a beacon, receive a QOS-Null message from the another wireless device indicating that the another wireless device is exiting a power save mode, cause the transmitter to transmit an acknowledgement of the QOS-Null message to the another wireless device, cause the transmitter to transmit the at least one of the plurality of transmit messages that comprises the okay-to-sleep flag, receive an acknowledgment of the at least one of the plurality of transmit messages that comprises the okay-to-sleep flag, receive the at least one of the plurality of messages that comprises the response, cause the transmitter to transmit an acknowledgment of the at least one of the plurality of messages that comprises the response, and re-enter the low power state, wherein the at least one of the plurality of transmit messages comprising the okay-to-sleep flag is generated before the beacon is transmitted.

10. The wireless device of claim 1, wherein the okay-to-sleep flag is in a header of the at least one of the plurality of transmit messages.

11. The wireless device of claim 10, wherein the header of the at least one of the plurality of transmit messages comprises an okay-to-sleep bit, and wherein the okay-to-sleep flag is set when the okay-to-sleep bit has a value of one.

12. The wireless device of claim 1, wherein the okay-to-sleep flag is a field in a payload of the at least one of the plurality of transmit messages.

13. The wireless device of claim 1, wherein the okay-to-sleep flag indicates the mode of the another wireless device after a message exchange sequence.

14. A wireless device comprising:
a receiver to receive a receive signal from another wireless device;
a transmitter to transmit a transmit signal to the another wireless device;
a data processing system to process a plurality of receive messages received from the another wireless device on the receive signal and generate a plurality of transmit messages to transmit to the another wireless devices on the transmit signal, and wherein at least one of the plurality of receive messages comprises an okay-to-sleep flag, and wherein at least one of the plurality of transmit messages comprises a response to the at least one of the plurality of receive messages comprising the okay-to-sleep flag, and wherein a header of the at least one of the plurality of transmit messages is set to indicate the wireless device is entering a power save mode.

15. The wireless device of claim 14, wherein the wireless device comprises a wireless station.

16. The wireless device of claim 14, wherein the data processing system comprises computer readable medium having computer executable instructions stored thereon which cause the data processing system to process the plurality of receive messages and generate the plurality of transmit messages.

17. The wireless device of claim 14, wherein the data processing system further generates an acknowledgement message in response to at least one of the plurality of receive messages comprising the okay-to-sleep flag, and wherein the transmitter further transmits the acknowledgment message to the another wireless device.

18. The wireless device of claim 14, wherein the another wireless device comprises an access point.

19. The wireless device of claim 14, wherein the receiver receives a beacon from the another wireless device and wherein the data processing system further processes the beacon.

20. The wireless device of claim 14, wherein the data processing system further causes the wireless device to enter the power save mode.

21. The wireless device of claim 17, wherein the wireless device switches to a low power mode when the data processing system causes the wireless device to enter the power save mode.

22. The wireless device of claim 17, further comprising a power supply and a real time clock in communication with the data processing system.

23. The wireless device of claim 17, wherein at least one of the transmitter and the receiver demand full power in an awake mode and neither the transmitter nor the receiver demand power during the power save mode.

24. The wireless device of claim 14, wherein the data processing system is further configured to wake up from a low power state, receive a beacon from another wireless device, cause the transmitter to transmit a QOS-Null message to the another wireless device indicating that the wireless device is exiting a power save mode, receive an acknowledgement of the QOS-Null message from the another wireless device, receive the at least one of the plurality of transmit messages that comprises the okay-to-sleep flag, cause the transmitter to transmit an acknowledgment of the at least one of the plurality of transmit messages that comprises the okay-to-sleep flag, cause the transmitter to transmit the at least one of the plurality of messages that comprises the response, receive an acknowledgment of the at least one of the plurality of messages that comprises the response, and re-enter the low power state.

25. The wireless device of claim 14, wherein the okay-to-sleep flag is in a header of the at least one of the plurality of receive messages.

26. The wireless device of claim 25, wherein the header of the at least one of the plurality of receive messages comprises an okay-to-sleep bit, and wherein the okay-to-sleep flag is set when the okay-to-sleep bit has a value of one.

27. The wireless device of claim 14, wherein the okay-to-sleep flag is a field in a payload of the at least one of the plurality of receive messages.

28. The wireless device of claim 14, wherein the okay-to-sleep flag indicates the mode of the wireless device after a message exchange sequence.

29. A method comprising:
causing a wireless station to wake up from a power save mode;
receiving a request message at the wireless station from an access point, the request message comprising an okay-to-sleep flag;
generating a response message, wherein generating the response message comprises setting a bit in the header of the response message to indicate the wireless station is entering a power save mode;
transmitting the response message to the access point; and
causing the wireless station to re-enter the power save mode.

30. The method of claim 29, further comprising periodically repeating the causing, receiving, generating, transmitting and causing steps.

31. The method of claim 29, wherein the request message comprises a header, and wherein the okay-to-sleep flag is in the header of the request message.

32. The method of claim 31, wherein the header comprises an okay-to-sleep bit, and wherein the okay-to-sleep flag is set when the okay-to-sleep bit has a value of one.

33. The method of claim 29, wherein the request message comprises a payload, and wherein the okay-to-sleep flag is a field in the payload.

34. The method of claim 29, wherein the okay-to-sleep flag indicates the mode of the wireless station after a message exchange sequence.

35. The method of claim 29, further comprising:
receiving a beacon from the access point;
generating a QOS-Null message indicating that the wireless station is exiting the power save mode;
transmitting the QOS-Null message to the access point;
generating an acknowledgement of the at least one of the plurality of transmit messages that comprises the okay-to-sleep flag before generating the response message;
transmitting the acknowledgement before generating the response message; and
receiving an acknowledgment of the response message from the access point before causing the wireless station to re-enter the power save mode.

36. A method comprising:
causing an access point to wake up from a power save mode;
generating a request message comprising a okay-to-sleep flag;
transmitting the request message from the access point to the wireless station;
receiving a response message at the access point from the wireless station, the response message indicating that the wireless station is entering a power save mode; and
causing the access point to re-enter the power save mode.

37. The method of claim 36, further comprising periodically repeating the causing, generating, transmitting, receiving and causing steps.

38. The method of claim 36, further comprising:
generating a beacon at the access point after causing the access point to wake up from the power save mode;
transmitting the beacon from the access point;
receiving a QOS-Null message at the access point from the wireless station indicating that the wireless station is exiting the power save mode;
generating an acknowledgement of the QOS-Null message;
transmitting the acknowledgement of the QOS-Null message from the access point to the wireless station;
receiving an acknowledgment of the request message at the access point from the wireless station after transmitting the request message and before receiving the response message;
generating an acknowledgment of the response message;
transmitting the acknowledgement of the response message from the access point to the wireless station before causing the access point to re-enter the power save mode.

39. The method of claim 36, wherein the request message comprises a header, and wherein the okay-to-sleep flag is in the header of the request message.

40. The method of claim 39, wherein the header comprises an okay-to-sleep bit, and wherein the okay-to-sleep flag is set when the okay-to-sleep bit has a value of one.

41. The method of claim 36, wherein the request message comprises a payload, and wherein the okay-to-sleep flag is a field in the payload.

42. The method of claim 36, wherein the okay-to-sleep flag indicates the mode of the wireless station after a message exchange sequence.
